(19) United States
(12) Patent Application Publication
(10) Pub. No.: US 2003/0229733 A1
(43) Pub. Date: Dec. 11, 2003

(54) DMA chaining method, apparatus and system

(76) Inventors: David Frank Hepner, San Jose, CA (US); Andrew Dale Walls, San Jose, CA (US)

Correspondence Address: Brian C. Kunzler, Suite 425, 10 West 100 South, Salt Lake City, UT, 84101, US

(21) Appl. No.: 10/163,288

(22) Filed: Jun. 5, 2002

(51) Int. Cl. G06F 13/28

(52) U.S. Cl. 710/24

(57) ABSTRACT

Related DMA transfers are chained by detecting a memory access to a selectable location corresponding to a first DMA transfer. A second DMA transfer may be initiated without CPU intervention in response to the detected memory access. Data transfers such as those related to data communications may be overlapped without waiting for reception of the entire communication. The present invention increases system throughput while reducing data latency and is particularly useful within systems that use intelligent peripherals or controllers. The architecture of the present invention permits deployment within existing systems using both chainable and conventional DMA devices.

### BACKGROUND OF THE INVENTION

1. The Field of the Invention

The invention relates to DMA devices, methods, and systems. Specifically, the invention is directed to improving the performance of DMA systems.

2. The Relevant Art

Direct Memory Access (DMA) circuitry is often incorporated within peripheral devices and controllers in order to increase system throughput and performance. Peripherals and devices with DMA support are able to access a memory relatively efficiently by using bursts of memory transactions setup by a CPU. DMA techniques are particularly useful within systems that regularly conduct I/O transactions, such as servers, storage controllers, host adaptors, network routers, data switches, and the like.

While DMA techniques relieve a CPU of many tedious memory transactions, considerable coordination and processing is often required of the CPU. For example, when transferring data among DMA capable devices, related DMA transfers involving write and read operations to common memory locations require that one DMA transfer finish before another transfer is initiated. In addition to requiring sequential execution, the resulting dependencies place a coordination and processing burden on the CPU or other controlling means.

Referring to FIG. 1, an example DMA system 100 will be used to illustrate the coordination and overhead required of currently available systems. The DMA system 100 includes a CPU 110, a memory bus 112, a program memory 120, a data memory 130, and one or more controllers 140 equipped with DMA circuitry 150. Each controller 140 is typically a peripheral controller, storage controller, data link, host adapter or the like. Typically, the controllers 140 interface with one or more data channels 142. The depicted data channels 142 are intended to be representative of the movement of information and thus are not shown as being restricted to any particular format or type of information.

In the depicted example, one controller is a receiving controller 140a, shown receiving data from a source channel 142a, while the other controller is a sending controller 140b shown transmitting data via a sink channel 142b. For example, the controller 140a may be a storage controller that is used to access specific data within a storage device. The controller 140b may be an output device used to control transmission of the data to a peripheral device such as a printer or video display.

The controller 140a places the data within the data memory 130, interrupts the CPU 110 and provides status information to the CPU. In turn the CPU 110 deciphers the status information, sets up another DMA transfer, responds to a second interrupt, and deciphers the updated status information. Relaying data from a data source such as the source channel 142a to a data sink such as the sink channel 142b requires several transfers and considerable coordination by the CPU 110. The initiated DMA transfers are sequentially executed and do not overlap.

FIG. 2 illustrates a data transfer method 200 depicting the steps typically involved when relaying data from a data source to a data sink using a plurality of controllers 140 such as those depicted in FIG. 1. The data transfer method 200 illustrates in further detail the amount of coordination, overhead, and transfer dependency involved in prior art methods for conducting data transfers between DMA devices.

The data transfer method 200 begins with a first initialization state 210. During the first initialization state 210, a CPU such as the CPU 110 provides a first DMA device, such as the receiving controller 140a, information regarding the designated placement of data within the data memory 130. For example, data such as a data stored within a disk drive may be expected to arrive from a data source such as the source channel 142a. The information provided by the CPU enables the first DMA device to place the expected data within the designated memory locations.

Upon reception of the data, the first DMA device streams the expected data via a DMA write sequence to the designated memory locations. Meanwhile, the CPU 110 is placed in a wait state 220. During the wait state 220, the CPU may also conduct other operations to use available processing cycles. However, within many systems, multitasking or I/O blocking may not be supported, requiring the CPU 110 to suspend or loop and thereby waste available processing cycles.

In conjunction with the wait state 220, the CPU 110 may poll a status location or be waiting for a particular interrupt that provides status information. Upon reception of the status information, the method 200 proceeds to a transfer completed test 230. The transfer completed test 230 ascertains whether the entire transfer has occurred. If the transfer has not been completed, the CPU loops to the wait state 220. If the transfer has completed, the CPU proceeds to a second initialization state 240.

During the second initialization state 240, the CPU provides a second DMA device, such as the sending controller 140b, information regarding the placement of data within a data memory such as the data memory 130. For example, data that was stored within a disk drive may have been placed within designated memory locations by the first DMA device. The data may be intended for a peripheral, or the like, associated with the second DMA device. Upon reception of the placement information (not shown,) the second DMA device, such as the sending controller 140b, streams the intended data via a DMA read sequence from the selected region of memory to the intended recipient.

During the DMA read sequence, the CPU 110 may be placed in a wait state 250. Similar to the wait state 220, the wait state 250 may require the CPU 110 to poll a status location or wait for a particular interrupt that provides status information. Upon reception of the status information, the CPU proceeds to a transfer completed test 260. The transfer completed test 260 ascertains whether the entire second transfer has occurred. If the transfer has not been completed, the CPU loops to the wait state 250. If the transfer has completed, the method ends 270.

The data transfer method 200 depicted in FIG. 2 illustrates a portion of the coordination and overhead required of a CPU when conducting DMA transfers. When relaying data between various controllers and peripherals, the CPU is required to set up, monitor, and process multiple individual transfers. Costly process swapping may be involved. Swapping of processes may be particularly costly when involving both application code and operating system code—a common occurrence. High-speed, low-latency, hardware-oriented DMA devices are required to wait while relatively slow-speed, high-latency, software routines process status information and conduct initialization sequences. Furthermore, the read and write DMA sequences are executed serially rather than in parallel. Serial execution often introduces delays resulting in relatively poor data throughput.

What is needed is a method and apparatus that facilitates early initiation of dependent DMA transfers while reducing the amount of coordination and overhead required of the CPU. Such a method and apparatus would be effective to reduce transfer latency and increase data throughput by facilitating parallel execution of dependent DMA transfers within DMA systems. Such a method and apparatus would also reduce the processing burden on the CPU or other controlling means.

### OBJECTS AND BRIEF SUMMARY OF THE INVENTION

The method and apparatus of the present invention have been developed in response to the present state of the art, and in particular, in response to the problems and needs in the art that have not yet been fully solved by currently available DMA systems and methods. Accordingly, it is an overall object of the present invention to provide an improved apparatus, system, and method for conducting DMA transfers.

To achieve the foregoing object, and in accordance with the invention as embodied and broadly described herein in the preferred embodiments, an improved apparatus, system, and several corresponding methods are presented for conducting chained DMA transfers. The improved apparatus, system, and methods facilitate parallel execution of related or dependent DMA transfers, which in prior art systems require serial execution and often require extensive interrupt handling resulting in undesirable processing loads and transfer gaps. Parallel execution of related or dependent DMA transfers increases data throughput, and decreases the latency of DMA systems.

A chainable DMA system of the present invention includes a CPU, one or more DMA devices, a memory configured to store data within a plurality of memory locations, and a DMA detector. The DMA detector detects DMA transfers and facilitates subsequent overlapped DMA transfers.

In one embodiment, the DMA detector comprises a comparator and a register configured to store a selected memory location. The comparator compares the selected memory location provided by the register with a memory access address. When the memory access address matches the selected memory location, the DMA detector provides a chaining signal to facilitate initiation of subsequent overlapped DMA transfers.

A chainable DMA device of the present invention integrates the DMA detector along with conventional DMA circuitry in a manner that facilitates subsequent overlapped DMA transfers. The subsequent DMA transfers may be initiated without additional CPU intervention.

A hardware-chained DMA method of the present invention is preferably conducted in conjunction with the chainable DMA device. The hardware-chained DMA method conducts a plurality of overlapped DMA transfers while minimizing CPU overhead. The hardware-chained DMA method initiates chained DMA transfers without requiring CPU intervention at the time of initiation.

The present invention also includes a software-chained DMA method that is preferable when conducting subsequent DMA transfers on DMA devices that do not support chaining. The software-chained DMA method leverages the DMA detection capabilities of the DMA detector to chain or initiate subsequent DMA transfers that may be overlapped to increase system performance.

The various aspects of the present invention may be deployed within DMA systems to achieve lower latency and higher throughput data communications. These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of a prior art DMA system that illustrates issues related to conducting DMA transfers;

FIG. 2 is a flow chart of a prior art transfer method that further illustrates issues related to conducting DMA transfers;

FIG. 3 is a schematic block diagram of data networking system depicting a typical application suitable for the present invention;

FIG. 4 is a block diagram depicting one embodiment of a chainable DMA system of the present invention;

FIG. 5a is a block diagram depicting one embodiment of a chainable DMA controller of the present invention;

FIG. 5b is a block diagram depicting one embodiment of a DMA detector of the present invention;

FIG. 6 is a flow chart depicting one embodiment of a hardware-chained DMA method of the present invention; and

FIG. 7 is a flow chart depicting one embodiment of a software-chained DMA method of the present invention.

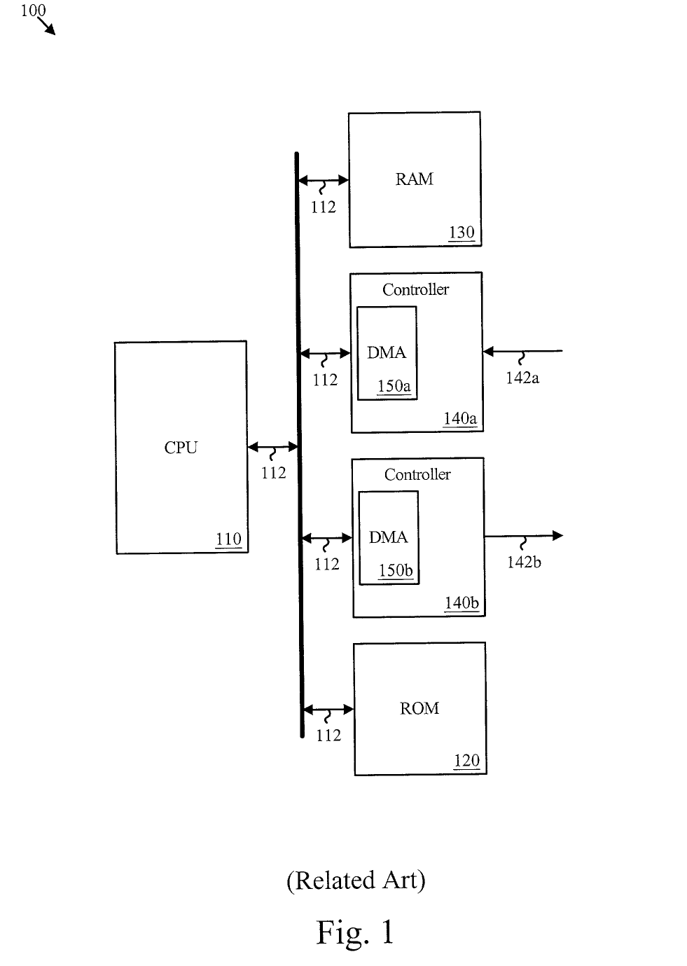

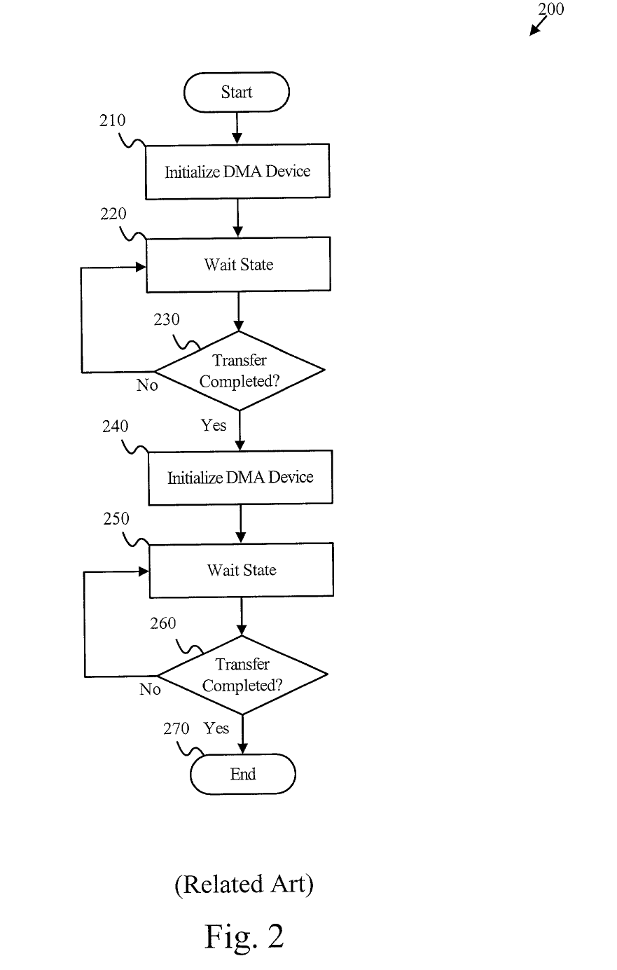

### DETAILED DESCRIPTION OF THE PREFERRED EMBODIMENTS

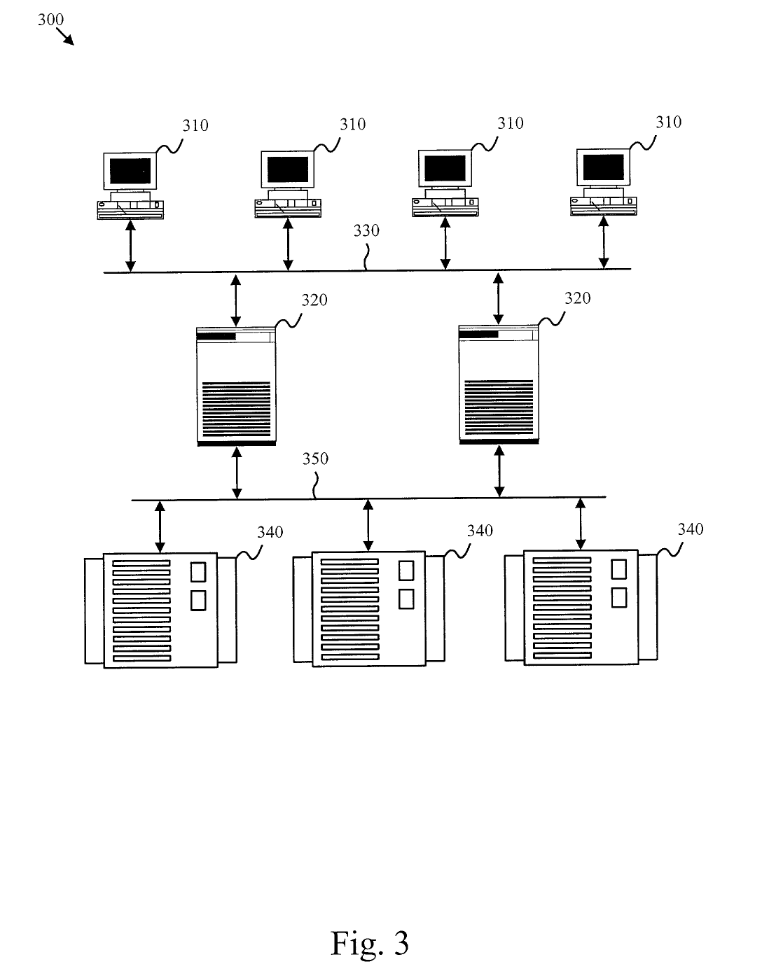

FIG. 3 shows a representative data networking system 300 suitable for application with the present invention. The data networking system 300, as shown, includes a number of workstations 310 and servers 320 interconnected by a local area network 330. The servers 320 may be configured to provide specific services such as print services, storage services, network routing, Internet access, data switching, and the like.

In the depicted embodiment, one or more of the servers 320 provide storage services to the local area network 330 via one or more storage arrays 340. The servers 320 are interconnected with the storage arrays 340 through a storage area network 350. In one embodiment, the storage area network 350 is a local area network in which the servers 320 and the storage arrays 340 are housed within the same facility or campus. In another embodiment, the storage area network 350 is a wide area network with the servers 320 and the storage arrays 340 housed in geographically disparate locations. The storage arrays 340 are preferably redundant and fault tolerant.

The data networking system 300 is preferably configured to accommodate large amounts of traffic, particularly data packets and messaging packets related to data storage, retrieval, and maintenance. Each of the processing elements with the data networking system 300 may be required to transfer large amounts of data internally between various controllers and interfaces to peripherals, communication links, I/O devices, and the like. The present invention provides means and methods to facilitate efficient and effective data transfers within, and data communications between, the processing elements of suitable computing networks including the data networking system 300 shown by way of example in FIG. 3.

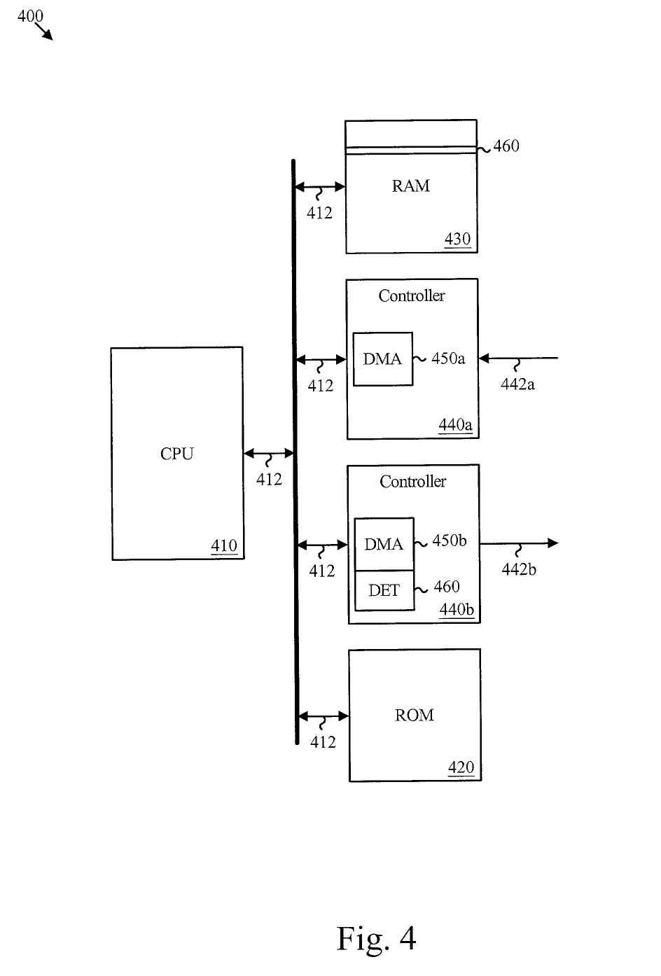

Referring to FIG. 4, a chainable DMA system 400 of the present invention addresses many of the problems and issues related to DMA methods and systems discussed in the Background Section. The chainable DMA system 400 facilitates parallel execution of related or dependent DMA transfers, which in prior art systems require serial execution and often require extensive interrupt handling resulting in undesirable transfer gaps.

The chainable DMA system 400 includes a CPU 410, a memory bus 412, a program memory 420, a data memory 430, and one or more controllers 440 equipped with DMA circuitry 450. The controllers 440 may each be a peripheral controller, storage controller, data link, host adapter, or the like. Typically, the controllers 440 interface with one or more data channels 442. The illustrated data channels 442 are intended to be representative of the movement of information under the present invention and need not be restricted to any particular format or type of information.

In the depicted example, one controller is a receiving controller 440a, shown receiving data from a source channel 442a, while the other controller is a sending controller 440b shown transmitting data to a sink channel 442b. For example, the controller 440a may be a storage controller that accesses requested data from a storage array such as a storage array 340. The requested data may be transmitted using a sending controller 440b to a peripheral device such as a printer or video display.

A detector 460 is preferably integrated with or otherwise in communication with the DMA circuitry 450 to facilitate DMA chaining. DMA chaining reduces the coordination and overhead required of the CPU 410 and improves data throughput. The detector 460 is preferably configured to detect a memory access to a selected location. The selected location may be within the data memory 430 and is preferably associated with an initial DMA transfer. Consequently, initiation of subsequent DMA transfers may be conducted with little or no CPU intervention. The DMA transfers may be overlapped, resulting in lower latency and increased data throughput for the chainable DMA system 400 relative to conventional DMA systems such as the DMA system 100.

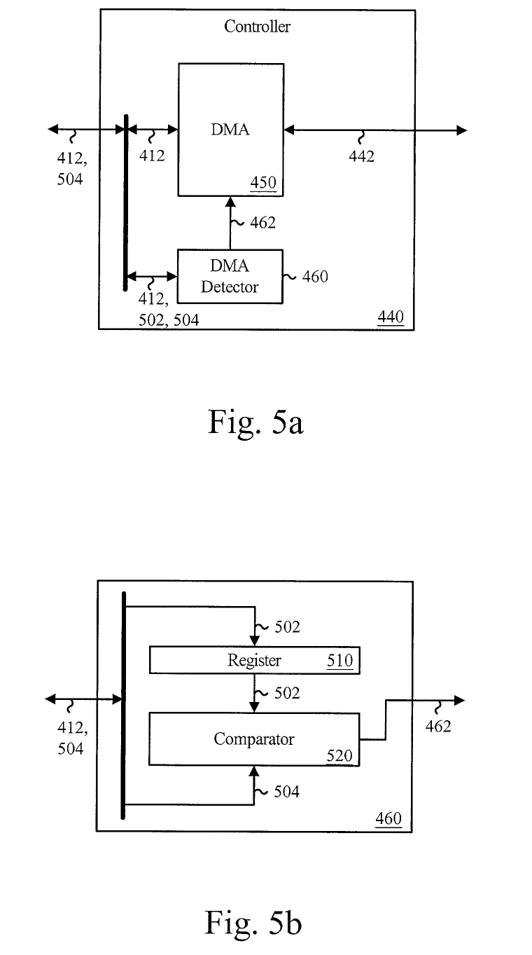

FIG. 5a is a block diagram illustrating one embodiment of a chainable DMA controller 440 of the present invention. The chainable DMA controller 440 may be a controller such as a peripheral controller, a storage controller, a data link adapter, host adapter, or the like. The chainable DMA controller 440 preferably includes the DMA circuitry 450 and the DMA detector 460 introduced in FIG. 4.

The DMA circuitry 450 provides DMA capabilities to the chainable controller 440. The DMA detector 460 detects memory accesses to a selected location 502. In the depicted embodiment, the selected location 502 is provided by a CPU (not shown) via the memory bus 412. The DMA detector 460 detects when a current address 504, corresponding to a memory access on the memory bus 412, references the selected location 502. In response to a memory access that references the selected location 502, the DMA detector asserts a chain signal 462.

In the depicted embodiment, assertion of the chain signal 462 indicates that a chained DMA transfer may now be initiated. As depicted, the DMA circuitry 450 receives the chain signal 462 and initiates a chained DMA transfer, which may be, for instance, a DMA read sequence from a designated range of memory locations updated during a previous DMA transfer. In other embodiments, the chain signal 462 may be received by a CPU or similar controlling means to facilitate early initiation of a chained DMA transfer.

The selected location 502 is preferably a memory location within the designated range of memory locations. The actual positioning of the selected location 502 within the range of locations is a design decision that may be influenced by a variety of system factors. For example, in those systems where DMA transfers are essentially synchronous to one another, for example due to the particular bus arbitration and transfer schemes, the first location may be selected without risk of a chained transfer overrunning a previous transfer.

In certain systems, however, DMA transfers may have mismatched or unpredictable transfer rates requiring a delay or lag between DMA transfers. A delay between DMA transfers is used to prevent a subsequent transfer from overrunning a previous transfer. The duration of the delay may be controlled by appropriate positioning of the selected location 502 within the range of memory locations associated with the transfers. Selecting the last location within the range eliminates the possibility of overrun by eliminating overlap between DMA transfers. While selecting the last location results in less than optimal data throughput, the advantage of reduced CPU overhead is still maintained.

FIG. 5b is a block diagram depicting one embodiment of the DMA detector 460 given by way of example. The depicted embodiment includes a register 510 and a comparator 520. The register 510 receives and provides the selected location 502. The comparator 520 monitors the memory bus 412 and compares the current address 504 with the selected location 502. In response to a match between the current address 504 and the selected location 502, the comparator 520 asserts the chain signal 462. In certain embodiments, the current address 504 may comprise an address range and the comparator 520 ascertains whether the selected location 502 is within the address range.

The depicted DMA detector 460 may be integrated within the DMA controller 440 or function as a standalone unit. When functioning as a standalone unit, the chain signal 462 provided by the DMA detector 460 may be coupled to a CPU interrupt or input line. Providing the chain signal 462 as an interrupt or input facilitates software chaining. Software chaining is typically not as responsive as hardware chaining. However, software chaining enables early initiation of overlapped transfers even when using DMA devices that have no hardware support for chaining.

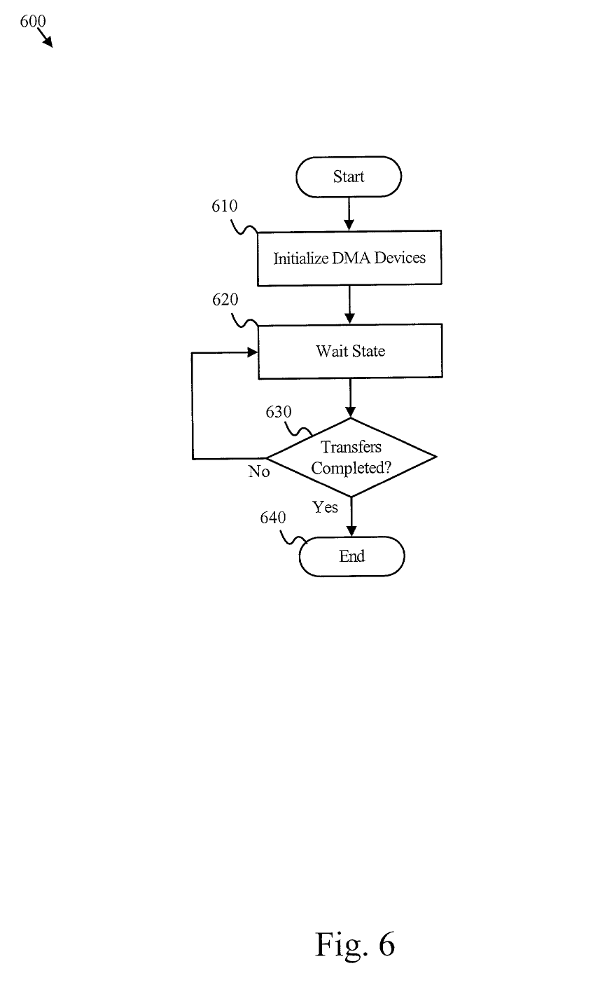

FIG. 6 is a flow chart depicting one embodiment of a chained DMA method 600 of the present invention. The chained DMA method 600 may be conducted in conjunction with the DMA controller 440 of the present invention. Using the chained DMA method 600, a plurality of DMA transfers are “chained” together to facilitate early initiation of the transfers and increased system performance.

The chained DMA method 600 includes an initialization state 610, a wait state 620, and a transfers completed test 630. The initialization state 610 initializes two or more DMA devices with data placement information. Placement information, such as a starting location and length, may be provided for both source and destination locations for the transfers associated with each DMA device.

The initialization state 610 initializes a DMA device for each DMA transfer that will be chained to a subsequent transfer. A DMA detector 460 or similar means is required for each chained transfer (except of course the last transfer, which by definition is not chained to a subsequent transfer). The DMA detector 460 is preferably integrated with, or otherwise in communication with, a DMA device such that DMA transfers may be automatically initiated in response to a detected DMA transfer.

The initialization state 610 places each associated DMA device in a ready state such that a specified transfer occurs when initiated, for example in response to assertion of a chain signal from the DMA detector 460. The present invention facilitates initiation of DMA transfers without requiring CPU intervention at the time of initiation. After completion of the initialization state 610, the method 600 proceeds to the wait state 620.

The wait state 620 may be conducted similar to the wait state 220 or the wait state 250 presented in the Background Section above. During the wait state 620, the CPU preferably conducts other operations to use available CPU cycles. However, in certain embodiments, multitasking or I/O blocking may not be supported, requiring the CPU to suspend or loop—thereby wasting available CPU cycles.

In conjunction with the wait state 620, the CPU may poll a status location or wait for a particular interrupt that provides status information. Upon reception of the status information, the chained DMA method 600 proceeds to a transfers completed test 630. The transfers completed test 630 ascertains whether the all of the intended DMA transfers have occurred.

In one embodiment, the transfers completed test 630 is limited to checking the status of the last DMA transfer in the chain. If the intended transfers have not been completed, the CPU loops to the wait state 620. If all of the transfers have occurred, the chained DMA method ends 640. In certain embodiments, the transfers completed test 630 may be limited to resuming processing as a result of activation of a suspended process associated with the wait state 620. For example, in response to an interrupt signal associated with the last DMA transfer in a DMA chain, the method 600 may resume processing without requiring express testing to ascertain completion of the intended transfers.

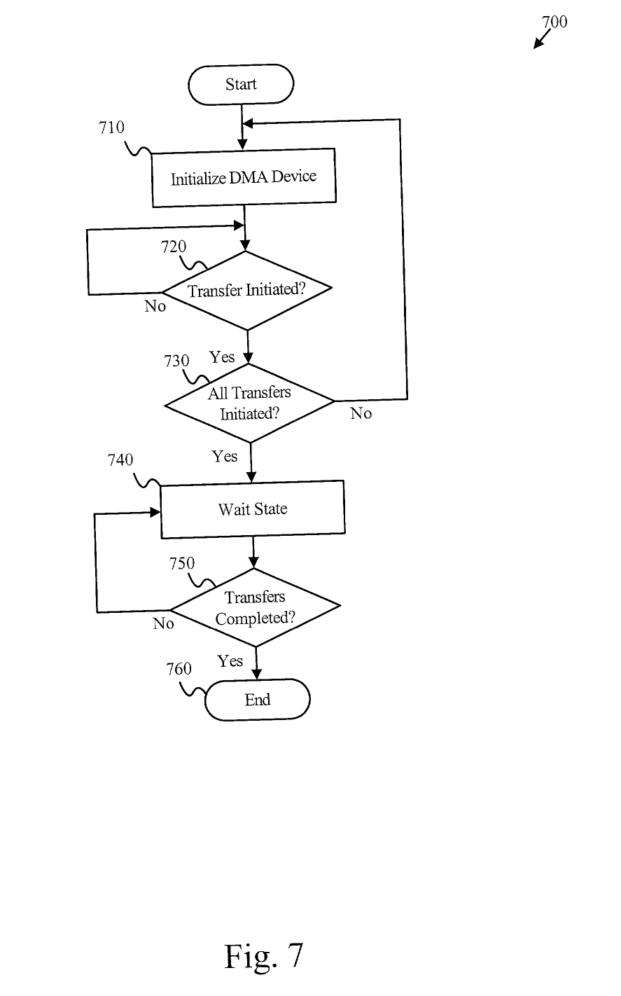

FIG. 7 is a flow chart depicting one embodiment of a software-chained DMA method 700 of the present invention. The software-chained DMA method 700 facilitates DMA chaining in those embodiments having one or more DMA detectors 460 that are not integrated within a DMA device. The use of DMA detectors external to an actual DMA device facilitates chaining and overlapped transfers within systems containing currently available DMA devices. The software-chained DMA method 700 includes an initialization state 710, a transfer initiated test 720, an all transfers initiated test 730, a wait state 740, and a transfers completed test 750.

The initialization state 710 initializes a single DMA device with data placement information such as the source and/or destination locations and transfer length. The software-chained DMA method proceeds from the initialization state 710 to a transfer initiated test 720. The transfer initiated test 720 ascertains whether the transfer just initiated has commenced, for example by reading a status register within the DMA device, polling the chain signal from the DMA detector 460, or receiving an interrupt in response to assertion of the chain signal by the DMA detector 460. If the initiated transfer has not commenced, the method suspends or loops, otherwise the method proceeds to the all transfers initiated test 730.

After the software-chained DMA method 700 ascertains that the transfer of immediate interest has commenced, the all transfers initiated test 730 ascertains whether all of the chained transfers have been initiated. In one embodiment, the all transfers initiated test 730 comprises decrementing a counter. If all of the transfers have not been initiated, the method 700 loops to the initialization state 710, otherwise the method proceeds to the wait state 740.

The wait state 740 is followed by the transfers completed test 750. The wait state 740 and the transfers completed test 750 are virtually identical to the wait state 620 and the transfers completed test 630. During the wait state 740, the CPU preferably conducts other operations to use available CPU cycles. In conjunction with the wait state 620, the CPU may poll a status location or be waiting for a particular interrupt that provides status information.

Upon reception of status information, the software-chained DMA method 700 proceeds to a transfers completed test 750. The transfers completed test 750 ascertains whether the all of the intended DMA transfers have occurred. In one embodiment, the transfers completed test 750 is limited to checking the status of the last DMA transfer in the chain. If the transfers have not been completed, the CPU loops to the wait state 740. If all of the transfers have occurred, the software-chained DMA method 700 ends 760.

The chained DMA method 600 and the software-chained DMA method 700 facilitate overlapped DMA transfers within DMA systems. The chained DMA method 600 minimizes CPU coordination and is preferably conducted with DMA devices configured to initiate DMA transfers in response to transfer detection and signaling means such as the DMA detector 460 and the chain signal 462. In those instances where a DMA device is not configured to receive a DMA detection signal such as the chain signal 462, the software-chained DMA method 700 facilitates chained DMA transfers. Thus, the software-chained DMA method 700 facilitates overlapped DMA transfers while using currently available DMA devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for chaining and overlapping DMA transfers, the method comprising:
detecting a first DMA transfer; and
conducting a second DMA transfer in response to the detected first DMA transfer.

2. The method of claim 1, wherein the first DMA transfer and the second DMA transfer are conducted by separate DMA devices.

3. The method of claim 1, wherein detecting a first DMA transfer comprises detecting access to a memory location corresponding to the first DMA transfer.

4. The method of claim 1, wherein detecting a memory access comprises comparing a target address with a memory access address.

5. The method of claim 4, wherein the target address corresponds to a first memory location accessed during the first DMA transfer.

6. The method of claim 4, wherein the target address corresponds to a memory location selected to avoid overrunning the first DMA transfer.

7. The method of claim 4, wherein the target address corresponds to a last memory location accessed during the first DMA transfer.

8. The method of claim 1, wherein the second DMA transfer is initiated via hardware means.

9. The method of claim 1, wherein the second DMA transfer is initiated via software means.

10. A method for chaining and overlapping DMA transfers, the method comprising:
detecting a memory access to a memory location corresponding to a first DMA transfer, the first DMA transfer comprising a plurality of write operations to sequential memory locations; and
conducting a second DMA transfer comprising a plurality of read operations from the sequential memory locations in response to the detected memory access, the first and second DMA transfers conducted on separate DMA devices.

11. An apparatus for conducting overlapped and chained DMA transfers, the apparatus comprising:
means for detecting a first DMA transfer;
means for conducting a second DMA transfer in response to detection of the first DMA transfer.

12. The apparatus of claim 11, further comprising means for initiating the second DMA transfer.

13. The apparatus of claim 12, wherein the means for initiating the second DMA transfer comprises hardware means.

14. The apparatus of claim 12, wherein the means for initiating the second DMA transfer comprises software means.

15. The apparatus of claim 11, wherein the means for detecting a first DMA transfer comprises means for detecting a memory access to a selectable location.

16. The apparatus of claim 15, wherein the means for detecting a memory access to a selectable location comprises means for storing the selectable location and means for comparing the selectable location with a memory access address.

17. An apparatus for conducting chained DMA transfers, the apparatus comprising:
a DMA transfer detector configured to detect a first DMA transfer; and
a DMA controller configured to conduct a second DMA transfer in response to detection of the first DMA transfer.

18. The apparatus of claim 17, wherein the DMA transfer detector is further configured to provide a chaining signal, and the DMA controller is further configured to receive the chaining signal.

19. The apparatus of claim 17, wherein the DMA transfer detector comprises means for detecting a memory access to a selectable location.

20. The apparatus of claim 17, wherein the DMA transfer detector comprises a register configured to store the selectable location and a comparator configured to compare the selectable location with a memory access address.

21. A system for conducting overlapping and chained DMA transfers, the system comprising:
a memory configured to store data within a plurality of memory locations;
a DMA detector configured to detect DMA transfers comprising at least one memory access to the memory and assert a chaining signal in response to detecting a selected DMA transfer;
a DMA device configured to receive the chaining signal and conduct a subsequent overlapping DMA transfer in response to assertion of the chaining signal; and
a CPU configured to set up DMA transfers on at least one DMA device.
